(19) United States
(12) Patent Application Publication
(10) Pub. No.: US 2025/0024787 A1
(43) Pub. Date: Jan. 23, 2025

(54) Grain Bin Filling System for a Combine Harvester

(71) Applicant: AGCO Corporation, Duluth, GA (US)

(72) Inventors: Bryan S. Claerhout, Hesston, KS (US); Ryan Armbrister, Hesston, KS (US)

(21) Appl. No.: 18/748,827

(22) Filed: Jun. 20, 2024

Related U.S. Application Data
(60) Provisional application No. 63/513,935, filed on Jul. 17, 2023.

(51) Int. Cl. A01F 12/46; A01F 12/60

(52) U.S. Cl. CPC A01F 12/46; A01F 12/60

(57) ABSTRACT

An auger for filling the grain bin of combine harvester has a reduced pitch of the auger at an upper section. This reduced pitch changes the angle at which grain is released from the auger, and thereby reduces the amount of grain that is undesirably ejected from the grain bin during filling of the grain bin.

### FIELD

Embodiments of the present disclosure relate generally to combine harvesters, and in particular to the grain bin filling system used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

The grain bin is filled by an auger which lifts the separated grain from the grain cleaning apparatus into the bin. The auger comprises an auger flight within an auger tube. A grain unloading system typically comprises another auger for lifting the grain from the grain bin and an unloading tube which extends from the top of the auger across to a location above the tractor trailer. The unloading system is turned on and off to control the emptying of the grain bin.

A problem which arises during filling of the grain bin is that grain is sometimes ejected from the grain bin from the top of the filling auger, in particular the top flight, as it rotates. The pitch of the auger dictates the rate at which grain is lifted up the filling auger hence is designed to enable filling of the grain bin at a rate corresponding to the harvesting of crop material. A larger pitch corresponds to a greater flow capacity. However, this also means grain is ejected from the auger with an upward angle (i.e. with a component parallel to the elongate axis of the auger) and this can result in grain being ejected from the grain bin.

CN-210868779U discloses an auger assembly for a combine harvester, in which there are two spiral blades at the outlet position (top) of the auger, each with the same screw pitch as the single spiral blade at the rest of the auger. The aim is to discharge the grain more stably and smoothly. However the angle of the top flight remains the same and the upward angle of ejection remains the same.

There is therefore a need for an improved grain bin filling system and in particular an improved system for folding the grain unloading tube.

### BRIEF SUMMARY

The invention is defined by the claims.

According to examples in accordance with the invention, there is provided an auger for filling the grain bin of combine harvester, comprising:
a lower section for receiving grain from a grain cleaning apparatus of the combine harvester, comprising an auger flight with a first pitch; and
an upper section for delivering grain to a grain bin of the combine harvester, comprising an auger flight with a second pitch, smaller than the first pitch.

The upper section of the auger has a reduced pitch, so that the angle of the flight is reduced (i.e., it is closer to perpendicular to the length axis of the auger). In this way, the grain reaching the top of the auger, and ejected from the top (or near the top) of the auger, has a reduced angle of elevation. This reduces the amount of grain that is undesirably ejected from the grain bin during filling of the grain bin. The change in auger pitch thus functions as a flow diverter, but without requiring any additional components.

The reduction in flight pitch may be abrupt or it may be gradual over one or more flight revolutions.

However, in all cases, the material carried axially by the auger will experience a reduction in axial velocity (i.e., along the length direction of the auger) when the material passes from the lower section to the upper section. The pitch is the axial distance between adjacent flight portions, wherein those flight portions are connected together to form a continuous auger flight, i.e., they are part of the same auger flight. For example, the two interleaved flights at the top of the auger of CN-210868779U each have the same pitch as the single flight at the rest of the auger. By adding a second interleaved auger flight to the top of the auger, there is no change to the tilt angle of the flight, or the axial velocity of the carried grain, because the pitch of each auger flight remains the same (there are two interleaved flights with the same pitch which is the same as the pitch of the single flight at the bottom).

In one example, a fraction of a flight revolution (i.e., less than one full revolution) of the upper section has said second pitch. Most grain is ejected from the top of the auger with only a last fraction of a flight, for example only the last 25% of the final flight revolution. Thus, the reduced pitch is only needed for a fraction of a flight revolution, preferably at the end of the auger. The final flight revolution is the last flight section along the flow path of the cleaned grain, and from which grain may be ejected with a high angle of elevation (with no downstream flight to function as a block).

In another example, at least one final flight revolution of the upper section preferably has said second pitch. This may be easier to manufacture.

In one example, exactly one flight revolution of the upper section has said second pitch. There may thus only be a single flight revolution with reduced pitch, but it is equally possible to have a set of flight revolutions with reduced pitch.

The second pitch is for example in the range 0.33 to 0.66 times the first pitch. The second pitch is for example 0.5 times the first pitch.

The auger for example is used together with an auger tube, and at least half of the upper section of the auger (i.e., the part with a reduced, second, pitch) projects beyond the auger tube. Preferably, all of the reduced pitch portion extends beyond the auger tube.

The invention also provides a combine harvester comprising:
a crop cutting head;
a threshing system;
a grain cleaning system for receiving the cut and threshed crop material;
a grain bin; and
the auger defined above for delivering grain from the grain cleaning apparatus to the grain bin.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows an example of a grain bin and grain bin filling auger; and

FIG. 4 shows the filling auger more clearly.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides an auger for filling the grain bin of combine harvester, in which there is a reduced pitch of the auger at an upper section. This reduced pitch changes the angle at which grain is released from the auger, and thereby reduces the amount of grain that is undesirably ejected from the grain bin during filling of the grain bin.

This disclosure relates to the design of the grain bin filling system. However, a general outline of a combine harvester will first be provided.

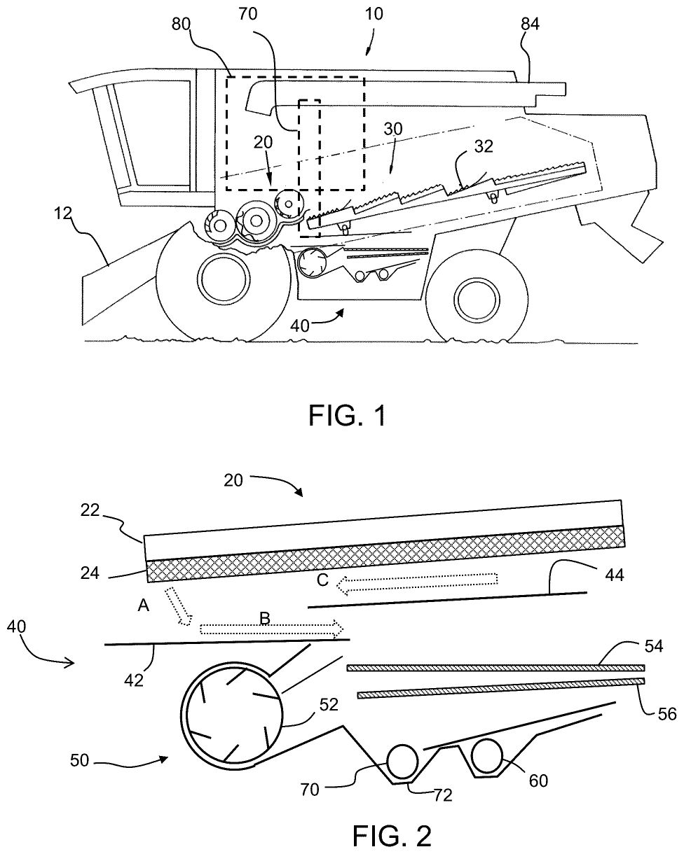

FIG. 1 shows a known combine harvester 10 to which the invention may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

An axial threshing (and separating) system 20 is shown in FIG. 2, together with a cleaning apparatus 40.

The threshing system 20 comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function involves conveying the crop stream rearwardly in a ribbon passing along a spiral path.

The initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 remove this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer/sieve.

This disclosure relates to the design of the grain lifting auger.

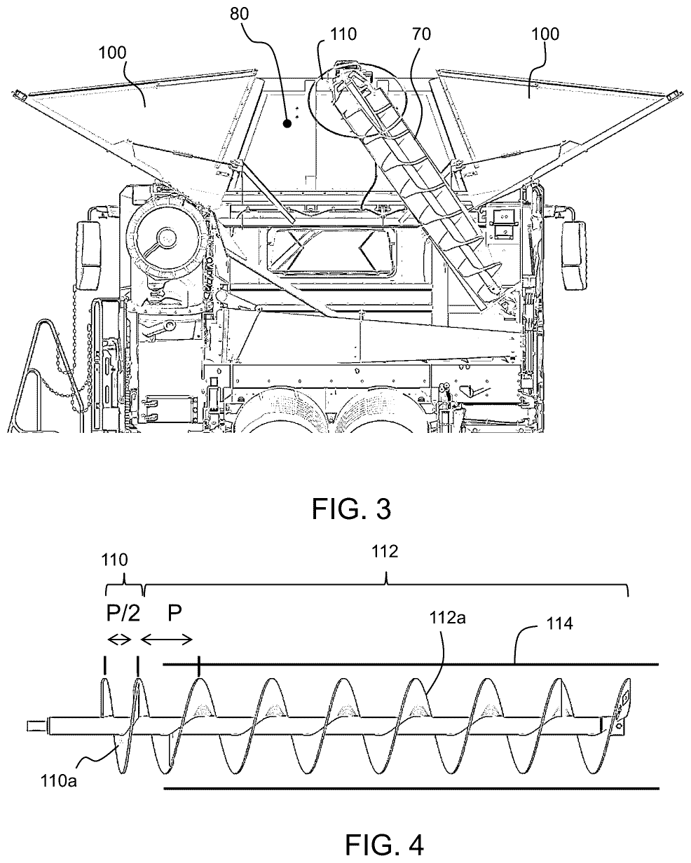

FIG. 3 shows a combine harvester incorporating a grain lifting auger 70 in accordance with this disclosure. FIG. 3 is a section view through the combine harvester, viewed from the rear of the combine harvester. The auger 70 fills the grain bin 80 and has an upper section 110 which extends to the top of the grain bin, so that the grain bin may be completely filled.

Covers 100 are shown as opened. The opened covers function as side walls to increase the volume of the grain bin when opened.

FIG. 4 shows the auger more clearly. It comprises the upper section 110 for delivering grain to a grain bin of the combine harvester and a lower section 112 for receiving grain from the grain cleaning apparatus of the combine harvester.

The lower section comprises a first auger flight 112a with a first pitch, shown as P in FIG. 4. The upper section 110 has a second auger flight 110a with a second pitch, smaller than the first pitch. In FIG. 4, the second pitch is shown as P/2.

The pitch of the first and second auger flights comprises the axial distance between adjacent flight portions of that auger flight. The portions between which the axial distance is measured are portions of the same single continuous auger flight (i.e., rather than a spacing between interleaved separate auger flights). The first and second auger flights are in series, and preferably have non-overlapping ends, so that the second auger flight starts at the location where the first auger flight ends. The two auger flights may in such a case be considered together to form a single continuous auger flight, but with a change in pitch along its length.

FIG. 4 also shows an auger tube 114 around the auger (and they together define an “auger arrangement”). The auger tube 114 defines a channel along which material is transported by the auger flight. The reduced pitch section 110 (i.e., the flight with the reduced second pitch) projects beyond the distal end of the auger tube 114. It defines the region at which material is ejected laterally by the auger flight rather than being transported along the tube. The reduced pitch section 110 may however extend partially into the auger tube, for example at least 50% and more preferably at least 75% and more preferably 100% of the reduced pitch section lies outside the auger tube 114.

The reduced pitch of the upper section means that the angle of the flight relative to the plane normal to the auger length) is reduced. In this way, the grain reaching the top of the auger, and ejected from the upper section of the auger, has a reduced angle of elevation. This reduces the amount of grain that is undesirably ejected from the grain bin during filling of the grain bin.

As shown, the flight with reduced pitch in this example comprises the last revolution of the auger flight, so it does not create an undesirable a resistance to the flow along the auger. In the example shown, the reduced pitch section comprises one flight revolution, i.e., it extends a length of one pitch. This is sufficient because the changed angle of the flight only needs to be the last flow directing surface impacted by the grain travelling up the auger. The reduced pitch may be for less than one flight revolution, for example 50% or less of a flight revolution, or even 25% of a flight revolution. The reduced pitch may instead extend over more than one revolution revolution. There does not need to be an integer number of revolutions with the reduced pitch. The reduced pitch section is preferably at the very end of the auger, but there could be a section of the auger beyond the reduced pitch section (in particular if all grain has been ejected, the functionality would not be changed by an additional section beyond the reduced pitch section).

The reduction in flight pitch may be abrupt so that there is a join between sections of different discrete pitches, or it may be gradual over one or more flight revolutions. For example, the pitch may evolve from a first pitch P to a second pitch (e.g., P/2) over a number of revolutions. Thus, the upper section 110 may have a length corresponding to multiple pitches, instead of the single pitch length shown in FIG. 4, and there may be a gradual or an abrupt reduction in pitch.

The reduced pitch is shown as 0.5 times the pitch of the lower section. More generally, the reduced pitch (or the final amount of the reduced pitch for a gradual pitch change) is for example in the range 0.33 to 0.66 times the first pitch.

The invention may be applied to any combine harvester design having an auger for delivering cleaned crop material up to a grain bin.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

All references cited herein are incorporated herein in their entireties. If there is a conflict between definitions herein and in an incorporated reference, the definition herein shall control.

1. An auger for filling the grain bin of combine harvester, comprising:
a lower section for receiving grain from a grain cleaning apparatus of the combine harvester, comprising a first auger flight with a first pitch; and
an upper section for delivering grain to a grain bin of the combine harvester, comprising a second auger flight with a second pitch, smaller than the first pitch.

2. The auger of claim 1, wherein the first and second auger flights together form a single continuous auger flight, with a change in pitch along its length.

3. The auger of claim 1, wherein the first and second auger flights are in series and are non-overlapping.

4. The auger of claim 1, wherein the upper section has a fraction of a flight revolution with said second pitch.

5. The auger of claim 1, wherein the upper section has at least one final flight revolution with said second pitch.

6. The auger of claim 5, wherein the upper section has exactly one flight revolution with said second pitch.

7. The auger of claim 1, wherein the second pitch is in the range 0.33 to 0.66 times the first pitch.

8. The auger of claim 7, wherein the second pitch is 0.5 times the first pitch.

9. An auger arrangement comprising the auger of claim 1 and an auger tube, wherein at least half of the second auger flight with the second pitch projects beyond the auger tube.

10. The auger arrangement of claim 9, wherein all of the second auger flight with the second pitch projects beyond the auger tube.

11. A combine harvester comprising:
a crop cutting head;
a threshing system;
a grain cleaning system for receiving the cut and threshed crop material;
a grain bin; and
the auger of claim 1 for delivering grain from the grain cleaning apparatus to the grain bin.
